(19) United States
(12) Patent Application Publication
(10) Pub. No.: US 2016/0171543 A1
(43) Pub. Date: Jun. 16, 2016

(54) ON-SITE SALES AND NEW PRODUCTS ADVERTISEMENTS SEARCH METHOD AND SYSTEM

(71) Applicants: Alfred Xueliang Xin, Cincinnati, OH (US); Sherry Xiaoli Sun, Cincinnati, OH (US)

(72) Inventors: Alfred Xueliang Xin, Cincinnati, OH (US); Sherry Xiaoli Sun, Cincinnati, OH (US)

(21) Appl. No.: 14/566,116

(22) Filed: Dec. 10, 2014

(51) Int. Cl. G06Q 30/02

(52) U.S. Cl. CPC G06Q 30/0257; G06Q 30/0261; G06Q 30/0277; G06Q 30/0267

(57) ABSTRACT

Shoppers in a shopping area may not be aware of all promotions available and pay more than the best offers via internet promotions. There is a need to invent an on-site sales and new products advertisements search method and system for onsite shoppers. The software application installed on a mobile device such as cellphone may utilize web map such as google map to locate the physical locations of shoppers, once shoppers submit request for shopping deals, data received from website(s) on available promotional commercials from stores within a range of the shoppers will be sent back and displayed on a map with store locations or floor layouts on the mobile device. Shoppers may get clear choices on what, where and how far the best deals are according visualized store locations and or floor layouts on an onsite map.

### BACKGROUND OF INVENTION

Shoppers go to the store and looking for good deals, or bring in sales coupons for shopping, and very likely they won't be able to get all the sales information, and further there is no way they may be able to get sales' information for the entire shopping area onsite based on accurate locations of the stores in the area. Therefore there is a need to invent an on-site sales and new products advertisements search method and system. A software application of said system may be installed on mobile electronic devices such as cellphone and smartphone, and it may utilize web map such as google map to locate the physical location of shoppers and submit requests for best deals in said shopping area.

Once shoppers submit request for sales and coupon deals, all and or categorize information and coupons available online for all stores and shops on a location map within a radius range of shoppers shall be sent back from websites and displayed on said mobile device. Shoppers may select and use those sales commercials and coupons with clear choices on what, where and how far are the best deals according visualized store locations and or floor layouts on an onsite map.

### FIELD OF THE INVNETION

The present invention generally relates to shopping and products sales and promotional coupons at or within a radius of location through internet geographical map search and website products sales and promotional postings. Such method and system shall provide shoppers with clear choices on what, where and how far the best deals are according visualized store locations and or floor layouts on an onsite map.

### SUMMARY OF THE INVENTION

An on-site sales and new products advertisements search method and system comprise of a software application installed or displayed on a web browser on a mobile electronic device, such as cellphone and smartphone, is coupled to and capable of receiving geographical locations information through digital map such as Google map and internet connection. Shoppers submit requests from said mobile device on shopping information from website(s), said requested information sends back from website(s) and displays on a map with actual locations of the stores and their best deals on screen of said mobile device.

Within the shopping area shoppers with said mobile device Said shoppers may be able to obtain all sales and new products information in different stores for all products or a specified information on certain merchandises and their offers; said shoppers may decide which store they would like to go shopping with clear choices and best deals according visualized store locations and or floor layouts on an onsite map.

Said shoppers may also be able to decide if it is worth to go a distance for a pricing difference between here and there; for shoppers new to an area or a location they may also be able to have complete pictures on where and how far stores are and what are the best deals and the merchandises they may be interested.

### BRIEF DESCRIPTION OF DRAWINGS

FIG. 1: A flow chart that demonstrates logical flows of an on-site sales and new products advertisements search method and system between onsite shoppers and a website with sales' commercials and coupons.

FIG. 2: A user interface flows for said on-site sales and new products advertisements search method and system for onsite shoppers in a shopping mall area, and deals selections based on shoppers' selections. FIG. 2-1 shows a home screen of a cellphone with “Shopping Deals” button. FIG. 2-2 shows first screen of said on-site sales and new products advertisements search method and system with its market name. FIG. 2-3 shows a flow map of mall displayed after a user selects “All Stores” button. FIG. 2-4 shows deals from a store after said user selects a store from said map. FIG. 2-5 shows deals with stores selling shoes within the mall.

FIG. 3: A user interface flows for said on-site sales and new products advertisements search method and system for onsite shoppers in a street shopping area, and deals selections based on shoppers' selections. FIG. 3-1 shows a home screen of a cellphone with “Shopping Deals” button. FIG. 3-2 shows first screen of said on-site sales and new products advertisements search method and system with its market name. FIG. 3-3 shows a street map with store and business layouts after user selected “All Stores” button. FIG. 3-4 shows deals from a store after said user selects a store from said street map. FIG. 3-5 shows deals with stores selling shoes from stores displayed on said street map near said user.

FIG. 4: A user interface flows for said on-site sales and new products advertisements search method and system for onsite shoppers inside a store. FIG. 4-1 shows a home screen of a cellphone with “Shopping Deals” button. FIG. 4-2 shows deals in a department store as user is in said department store.

### PREFFERED EMBODIMENT

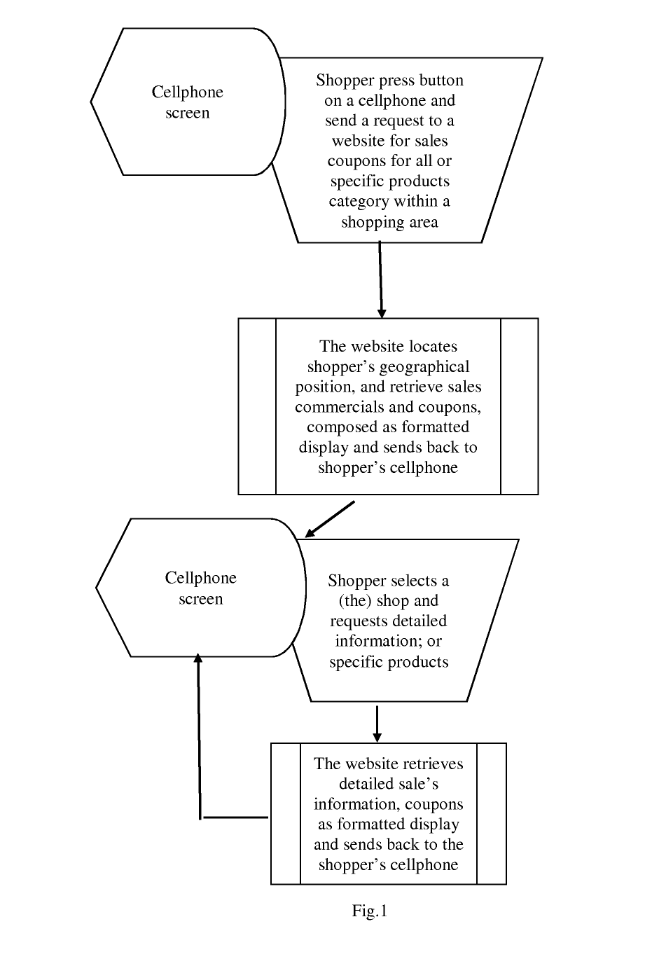

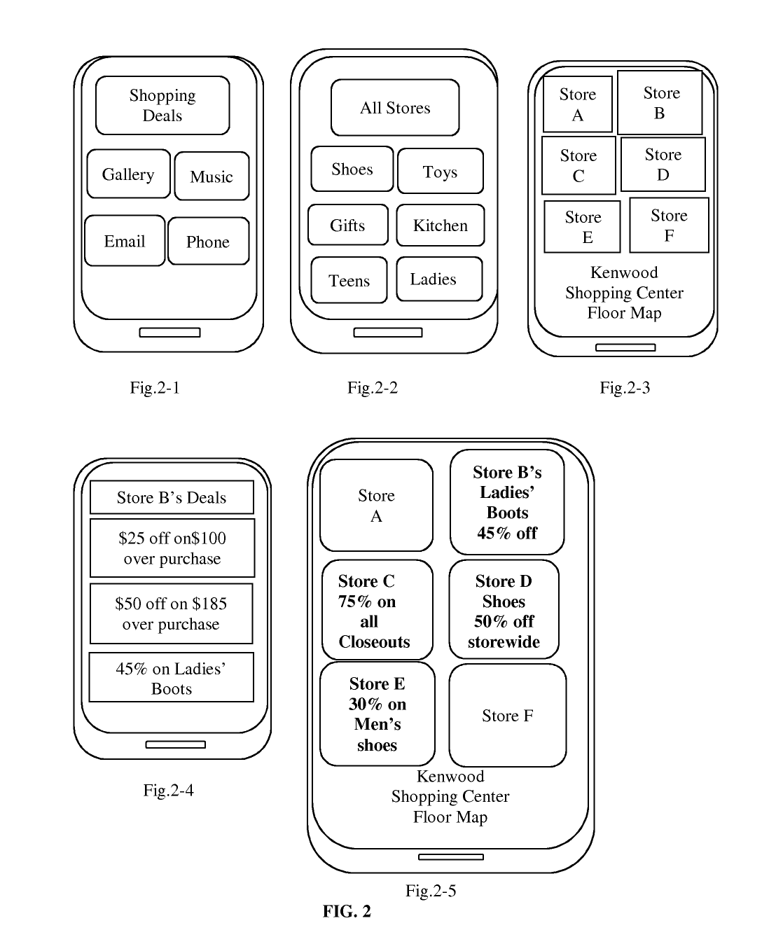

Referencing to drawings, in FIG. 1 and FIG. 2 of a preferred embodiment of said on-site sales and new products advertisements search method and system. A shopper is in a shopping mall area and has a cellphone installed with an on-site sales and new products advertisements search software displayed as “Shopping Deals” and connected to internet and google map. Said shopper selects “Shopping Deals” button (FIG. 2-1) on his cellphone and then selects “All Stores” button (FIG. 2-2) in an attempt to get sales' information and discount coupons in the entire shopping mall area. Said software on said cellphone then sends a request on searching sales deals for the entire shopping mall area within said shopping mall to a website(s).

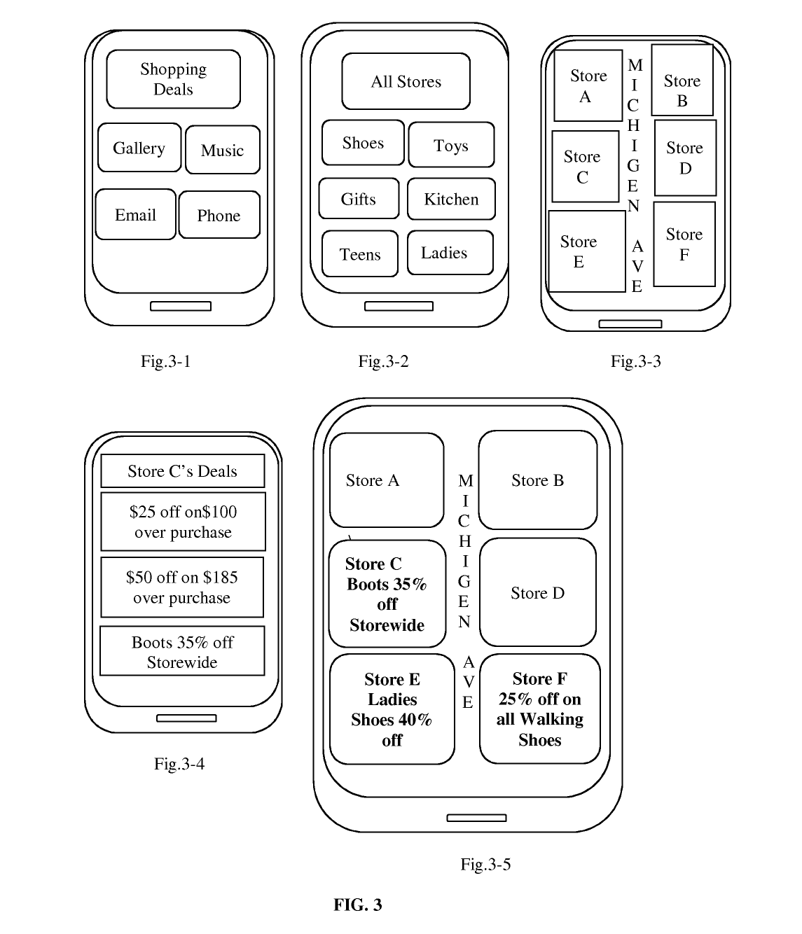

Said cellphone receives all sales information from all the stores in said shopping mall from said website(s) and displays all the stores heighted that have sales offers (FIG. 2-3) on a floor map on the screen of said cellphone.

Said shopper requests sales information from a store by touching said store's location and name on said floor map and the request is sent back to said website(s). Said website(s) sends back entire available sales discounts offers posted by said store back to said cellphone and displays said commercial images on its screen (FIG. 2-4).

Referencing to drawings, in FIG. 1 and FIG. 2 of another preferred embodiment of said on-site sales and new products advertisements search method and system displayed on a cellphone as “Shopping Deals”. A shopper is in a shopping mall area and has a cellphone connected to internet and google map. Said shopper selects “Shopping Deals” button (FIG. 2-1) on his cellphone and then selects “Shoes” button (FIG. 2-2) selecting to get sales' information and discount coupons for a particular merchandise category. Said cellphone then sends a request on searching sales deals for the entire shopping area within said shopping mall to website(s).

Said sales information on said merchandise category from all stores with said merchandise in said shopping mall are sent back with all sales offers by said stores to said cellphone and displayed on said cellphone with commercial images on its screen (FIG. 2-5).

Referencing to drawings, in FIG. 1 and FIG. 3 of still another preferred embodiment of said on-site sales and new products advertisements search method and system displayed as “Shopping Deals” on a cellphone screen. A shopper is in a shopping street area with said cellphone connected to internet and google map. Said shopper selects “Shopping Deals” button (FIG. 3-1) on his cellphone and then selects “All Stores” button (FIG. 3-2) trying to get sales' information and discount coupons from stores within a range of said shopping area. Said cellphone then sends a request on searching sales deals for all stores within a range of said shoppers' physical position to website(s).

Said mobile device receives all sales information from all the stores in a range of said shopper's physical position and displays an area map with all the stores heighted that have sales offers (FIG. 3-3) on its screen.

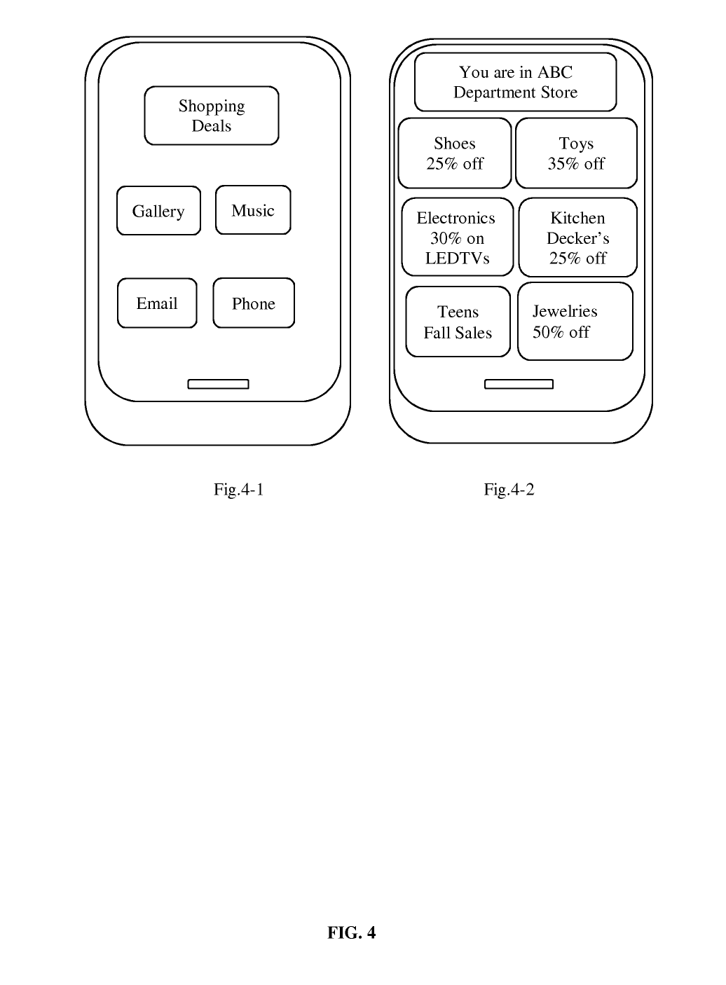

Said shopper requests sales information from a store by touching said store's location on said onsite map and the request is forwarded to said website(s), said mobile device receives entire available sales discounts offers posted by said store from said website(s), and displays said commercial images on its screen (FIG. 3-4).

Referencing to drawings, in FIG. 1 and FIG. 3 of still another preferred embodiment of said on-site sales and new products advertisements search method and system. A shopper is in a shopping street area and has a cellphone connected to internet and google map. Said shopper selects “Shopping Deals” button (FIG. 3-1) on his cellphone and then selects “Shoes” button (FIG. 3-2) selecting to get sales' information and discount coupons for a particular merchandise category. Said cellphone then sends a request on searching sales deals for the entire shopping area within a range of said shoppers' physical position to web site(s).

Said mobile device receives all sales information on said merchandise category from all stores with said merchandise in said shopping street area and displays lists all sales offers with said commercial images on its screen (FIG. 3-5).

Referencing to drawings, in FIG. 1 and FIG. 4 of still another preferred embodiment of said on-site sales and new products advertisements method and search method and system displayed on a cellphone as “Shopping Deals”. A shopper is in a department store and has said cellphone connected to internet and google map. Said shopper selects “Shopping Deals” button (FIG. 4-1) on his cellphone. Said google map detects that said shopper is in a single unit commercial building at a postal address, and said cellphone then sends a request on searching sales deals for the entire department store to website(s).

Said cellphone receives all sales information on said department store and displays said commercial images on its screen (FIG. 4-2).

The embodiments are mainly illustrations on the invention, advantages of the invention will be set forth in part in the description which follows, and in part will be obvious from the description, or may be learned by practice of the invention. The advantages of the invention will be realized and attained by means of the elements and combinations particularly pointed out in the claims. Further it is to be understood that both the foregoing general descriptions and detailed descriptions are exemplary and explanatory only and are not limited to the invention as claimed.

It claims:

1. An on-site sales and new products advertisements search method and system comprising:
a. a software application installed on a mobile device such as a cellphone coupled to internet connection and a web-map such as google map or GPS (Global Position System);
b. said software application on said mobile device capable of sending requests on commercial and sales information posted by stores on said internet and of receiving said sales information from said internet;
c. said mobile device is capable of displaying said sales information on a store-layout map according to their actual street locations and or actual floor layouts within a radius range of said mobile device.

2. The on-site sales and new products advertisements search method and system of claim 1 wherein said software application on said mobile device coupled with said web-map is capable of updating and sending accurate physical location of said mobile device to said internet.

3. The on-site sales and new products advertisements search method and system of claim 1 wherein said software application on said mobile device coupled to graphic user interface is capable of submitting various requests by user on new products and sales information posted online by stores and shops within a radius range, postal address and or at location of said mobile device; and displays requested information sent back by said internet according to a store-layout map according to their actual street locations and or actual floor layouts within a radius range of said mobile device.

4. The on-site sales and new products advertisements search method and system of claim 1 wherein said software application on said mobile device may be deployed on a web browser installed to said mobile device.

5. The on-site sales and new products advertisements search method and system of claim 1 wherein said software application on said mobile device is capable of displaying floor layouts only within structures of a building at a postal address.

6. The on-site sales and new products advertisements search method and system of claim 1 wherein said software application is capable of submitting requests to multiple internet websites and optimizing searching results, and displays selected best deals and options on its screen.

7. The on-site sales and new products advertisements search method and system of claim 1 wherein said software application is capable of communicating with preconfigured website(s) only.

8. An on-site sales and new products advertisements search method and system comprising a software application installed on a mobile device such as a cellphone coupled to internet connection and a web-map such as google map or GPS (Global Position Method and system) and graphic user interface on said mobile device, or deployed via a web browser on said mobile device, and capable of submitting various requests to internet(s) by user on new products and sales commercials posted by stores and shops on said internet(s) within a range, postal address and or at location of said mobile device, and displays said sales and new products commercials on store-layout map according to their actual street locations and or actual floor layouts within a radius range of said mobile device on said mobile device;
Said software application on said mobile device is capable of searching sales and new products commercials within a physical range of said mobile device and is also capable of searching multiple internet websites and selecting best deals on sales and new products commercials based on all products sales and or selected categories and products specifications.

9. The on-site sales and new products advertisements search method and system of claim 8 wherein said software application is capable of communicating with preconfigured website(s) only.

10. An on-site sales and new products advertisements search method and system comprising steps of: a software application coupled with web-map such as google map and internet connection installed on a mobile device such as cellphone is capable of submitting requests on commercial sales information to internet website(s); shoppers with said software application on said mobile device are capable of requesting and receiving sales and new products information from internet website(s), and said mobile device displays said sales and new products information requested by said shoppers on a store-layout map according to their actual street locations and or actual floor layouts within a radius range of said mobile device on said mobile device;
Said shoppers with software application on said mobile device are also able to submit and search multiple internet websites, and select best deals on sales and new products commercials based on all products sales and or selected categories and products specifications;
said software application is capable of communicating with preconfigured website(s) only.
